(19) United States
(12) Patent Application Publication
(10) Pub. No.: US 2019/0241338 A1
(43) Pub. Date: Aug. 8, 2019

(54) PEELABLE LABEL

(71) Applicant: ESSENTRA PACKAGING & SECURITY LIMITED, Buckinghamshire (GB)

(72) Inventor: David IBBITSON, Nottingham (GB)

(21) Appl. No.: 16/330,962

(22) PCT Filed: Sep. 7, 2017
(86) PCT No.: PCT/GB2017/052606

§ 371 Date: Mar. 6, 2019

(30) Foreign Application Priority Data
Sep. 7, 2016 (GB) 1615221.7

(51) Int. Cl. B65D 75/58; G09F 3/00; G09F 3/10

(52) U.S. Cl. CPC B65D 75/5838; G09F 3/0288; G09F 2003/0222; B65D 2577/2041; G09F 3/10

(57) ABSTRACT

A peelable label including a main panel and a finger lift tab. The main panel and the finger lift tab include a first film, and the finger lift tab includes one or more layers of a chemical composition configured to cause the finger lift tab to be deflected from the plane of the main panel.

The invention relates to a peelable label, and is particularly, although not exclusively, concerned with a peelable label in the form of an opening label for opening packaging. The invention is also concerned with packaging incorporating such a peelable label, and with a method of manufacturing a peelable label.

It is known to provide products in sealed and hermetically sealed packages in order to preserve freshness and/or integrity. Such packages may be so-called “filmic and filmic/foil packets” formed from a film and/or foil material. The filmic packet is typically provided with an opening such that the product can be removed from the packet. In a previously considered arrangement the opening is a pre-formed cut in the filmic or filmic/foil packet which defines an opening panel, and an opening label is adhered over the opening/opening panel. When the opening label is pulled away from the filmic or filmic/foil packet the opening panel is detached from the filmic or filmic/foil packet to expose the opening. In order to preserve the freshness and/or integrity of the product, the label is resealable and so can be re-adhered over the opening. Such an arrangement is disclosed in EP 1 102 712, for example.

Typically, the opening label has a finger lift tab which projects from the main panel of the label and is not adhered to the filmic or filmic/foil packet. The user is able to grasp the tab to peel the opening label away from the filmic or filmic/foil packet. This can be a somewhat fiddly operation; the tab may be small, and may lie in contact with the filmic packet so that the user has to use a fingernail to lift the tab before it can be grasped firmly enough to peel away the label.

Typical methods of producing labels having raised finger lift tabs often require complex processes in order to raise the finger lift tab and maintain the finger lift tab in a raised (deflected) position, for example, cutting the label or using jets of pressurised air. It has also been difficult to produce a label having a raised finger lift tab, in which the finger lift tab remains deflected from the plane of the main part of the label.

Furthermore, labels having finger lift tabs positioned at the label's corner present further challenges for production. Existing production methods may only provide such labels which have a finger lift tab that demonstrates unacceptable deflection and/or a finger lift tab that does not remain deflected during use.

Thus, there is a need for a peelable label having a raised finger lift tab, in which the finger lift tab can be located in a number of positions with respect to the label and in which the finger lift tab is deflected from the plane of the packaging and remains deflected during use. There is also a need for a simple process to provide such a peelable label.

According to a first aspect of the present invention there is provided a peelable label comprising:

a main panel and a finger lift tab;

wherein the main panel and the finger lift tab comprise a first film; and

wherein the finger lift tab comprises one or more layers of a chemical composition configured (e.g. applied thereto, e.g. applied to the upper surface of the finger lit tab) to cause the finger lift tab to be deflected from the plane of the main panel.

Preferably, the chemical composition comprises a varnish, e.g. the chemical composition is a varnish.

The peelable label may have a single layer construction comprising the first film and the one or more layers of varnish, for example the peelable label may comprise the first film only, together with the one or more layers of varnish.

The peelable label may further comprise a second film (e.g. a base film) which is coextensive with the main panel, such that the finger lift tab is defined by the portion of the first film that is not coextensive with the main panel. In this configuration, the main panel comprises a first film (e.g. a lamination film) and a second film (e.g. a base film), and the finger lift tab comprises the first film and the one or more layers of the chemical composition (e.g. varnish). The second film is not coextensive with the finger lift tab, i.e. the finger lift tab does not include the second film.

The one or more layers of the chemical composition (e.g. varnish) may be disposed on the upper surface of the first film of the finger lift tab.

It has been found that a peelable label having the above configuration provides a finger lift tab having a remarkable and sustained deflection from the plane of the main panel.

It is desirable for a finger lift tab not to include adhesive on its underside to make it easier for the user to grasp and to prevent it from adhering to the packaging surface or other surfaces during use. It has been found that a peelable label having a finger lift tab that does not include a second film provides an adhesive free finger lift tab without the need for an adhesive deadening layer or a second film that is partially coated with adhesive.

Having a main panel that comprises a first and a second film and a finger lift tab that does not include the second film means that there is a step at the boundary between the finger lift tab and the main panel. This step helps to deflect the finger lift tab from the plane of the main panel.

Including one or more layers of a chemical composition (e.g. varnish) to cause the finger lift tab to be deflected is a simple and economical solution that avoids the need for a crease or cut to be formed between the main panel and the finger lift tab, and may also avoid the need for jets of air to raise the finger lift tab.

The first film may comprise a polymer, for example a biaxially oriented polymer, for example bi-axially oriented polypropylene (BOPP) or a polyester. The first film may have a thickness of from 10 μm to 100 μm, for example 30 μm. The first film may be transparent, for example a transparent BOPP film.

The total chemical composition (e.g. varnish) thickness (I.e. the total thickness of the one or more layers of the chemical composition (e.g. varnish)) may be from 10 to 40 μm. The one or more layers of chemical composition (e.g. varnish) may comprise a single or multiple layers of the chemical composition (e.g. varnish). It has been found that the single or multiple layers of a chemical composition (e.g. varnish) leads to a finger lift tab having an acceptable aesthetic appearance as well as a significant and sustained deflection from the plane of the main panel. The varnish may comprise a UV flexo or screen varnish, and may have a gloss or matte finish.

Without being bound to any particular theory, it is hypothesised that cross linking within the varnish when the varnish is cured leads to a contraction of the first film, thereby causing the finger lift tab to be deflected in the plane of the main panel.

The second film may comprise a polymer, for example a biaxially oriented polymer, for example bi-axially oriented polypropylene (BOPP), for example a metallised BOPP, polyester, polyethylene or any suitable filmic label stock material known in the art. The second film may have a thickness of from 30 μm to 100 μm, for example 50 μm.

In the case that the peelable label comprises a first and a second film, as described above, the peelable label may further comprise a layer of lamination adhesive disposed between the first film and the second film. The lamination adhesive may be any suitable lamination adhesive known in the art, for example a water based acrylic adhesive, solvent based acrylic adhesive, hot melt adhesives, UV cured adhesive and the like.

Preferably, the peelable label further comprises a layer of resealable adhesive disposed on the underside of the peelable label, for example the underside of the main panel.

In the case of the peelable label comprising a first film and a second film, the resealable adhesive may be disposed on the underside of the second film (only). In this way, the first film remains free of resealable adhesive, so that the finger lift tab remains free of resealable adhesive.

In the case of the peelable label having a single layer construction comprising a first film (and not a second film), the resealable adhesive may be disposed on the underside of the main panel only. Alternatively, the resealable adhesive may be disposed on the underside of the main panel and the finger lift tab, and an adhesive deadening layer may be disposed on the underside of the finger lift tab to thereby deaden the adhesive on the underside of the finger lift tab to prevent the finger lift tab from adhering, in use, to for example, a release liner, packaging or other objects.

The resealable adhesive may be an adhesive that remains substantially adherent after continuous use. For example, a film may be coated with a resealable adhesive to enable the film to be adhered to a substrate. The resealable adhesive enables the film to be repeatedly removed from the substrate and re-adhered to the substrate without a significant reduction in adhesiveness. The resealable adhesive may be any suitable resealable adhesive, for example a pressure sensitive adhesive, a water based adhesive, solvent based adhesive, a UV cured adhesive, a hot melt adhesive or other suitable resealable adhesives known in the art.

The second film may be printed with colour, text, images and branding etc. The second film may be printed by, for example, gravure printing, flexo printing, litho printing, digital printing or other suitable printing methods known in the art.

The finger lift tab may extend longitudinally from the main panel, such that an edge of the peelable label is deflectable from the plane of the main panel.

The finger lift tab may extend from the main panel towards a corner of the peelable label, such that the corner of the peelable label is deflectable from the plane of the main panel. In this configuration, the finger lift tab is positioned in the corner of the peelable label, such that in use the user can grasp a corner of the peelable label.

The peelable label may comprise two finger lift tabs, each finger lift tab extending from the main panel towards a corner of the peelable label, such that each corner of the peelable label is deflectable from the plane of the main panel. In this configuration, the finger lift tab is positioned in each corner of the peelable label, such that in use the user can grasp either or both corners of the peelable label.

In a further aspect of the present invention there is provided a wound reel of peelable labels, comprising a release liner and a plurality of peelable labels according to any statement set out above, releasably adhered to the release liner. The release liner may be any suitable release liner, for example a polyester or glassine release liner.

Herein, the term releasably adhered includes the meaning in which, for example, a first substrate has the ability to adhere to a second substrate and then be removed easily from the second substrate, without substantially damaging the first substrate. In use, the main panel is applied to a package (e.g. to seal an opening in the package) and is releasably adhered to the packaging so that it can be removed (e.g. partially removed) to open the packaging, and re-adhered to close the packaging. This opening and closure may be performed many times.

In a further aspect of the present invention there is provided packaging for at least one article or substance, comprising:

a main packaging portion having a packaging opening; and
a peelable label according to any statement set out above,
the peelable label being adhered to the main packaging portion with the main panel covering the packaging opening and at least part of the finger lift tab being deflected away from the main packaging portion;
wherein, in use, pulling the main panel away from the main packaging portion by means of the finger lift tab causes the packaging opening to be exposed.

In a further aspect of the present invention there is provided a method of manufacturing a peelable label comprising:
forming a first film having a main panel region and a fingerlift tab region;
applying a layer of resealable adhesive to the main panel region;

and applying one or more layers of a chemical composition (e.g. varnish) to the finger lift tab region of the first film to thereby cause the finger lift tab region to deflect from the plane of the main panel region.

The resealable adhesive may be applied to the underside of the main panel region (only). Alternatively, the resealable adhesive may be applied to the underside of the main panel region and the finger lift tab region. An adhesive deadening layer is then applied to the finger lift tab region to deaden the adhesive in the finger lift tab region to prevent the finger lift tab from adhering, in use, to for example, a release liner, packaging or other objects.

The one or more layers of a chemical composition (e.g. varnish) may be applied to upper surface of the finger lift tab region.

The first film may comprise a polymer, for example a biaxially oriented polymer, for example bi-axially oriented polypropylene (BOPP) or a polyester. The first film may have a thickness of from 10 μm to 100 μm, for example 30 μm. The first film may be transparent, for example a transparent BOPP film.

The method may comprise applying single or multiple layers of a chemical composition (e.g. varnish) to the finger lift tab region of the first film. The one or more layers of the chemical composition (e.g. varnish) applied may result in a total thickness of the chemical composition (e.g. varnish) (I.e. the total thickness of the one or more layers of the chemical composition (e.g. varnish)) being from 10 to 40 μm.

The varnish may comprise a UV flexo or screen varnish, and may have a gloss or matte finish.

In a further aspect of the present invention there is provided a method of manufacturing a peelable label comprising:

forming a second film comprising a main panel region and a finger lift tab region;
cutting the second film to remove the finger lift tab region;
bonding a first film to the second film to thereby form a peelable label comprising a main panel and a finger lift tab, wherein the finger lift tab is defined by the portion of the first film that is not coextensive with the main panel;
applying one or more layers of a chemical composition (e.g. varnish) to the finger lift tab to thereby cause the finger lift tab to be deflected from the plane of the main panel.

The first film may comprise a polymer, for example a biaxially oriented polymer, for example bi-axially oriented polypropylene (BOPP) or a polyester. The first film may have a thickness of from 10 μm to 100 μm, for example 30 μm. The first film may be transparent, for example a transparent BOPP film.

The resealable adhesive may be applied to the underside of the main panel region. The one or more layers of a chemical composition (e.g. varnish) may be applied to the upper surface of the finger lift tab region.

The method may comprise applying single or multiple layers of a chemical composition (e.g. varnish) to the finger lift tab region of the first film. The one or more layers of the chemical composition (e.g. varnish) applied may result in a total thickness of the chemical composition (e.g. varnish) (I.e. the total thickness of the one or more layers of the chemical composition (e.g. varnish)) being from 10 to 40 μm.

The varnish may comprise a UV flexo or screen varnish, and may have a gloss or matte finish.

The second film may comprise a polymer, for example a biaxially oriented polymer, for example bi-axially oriented polypropylene (BOPP), for example a metallised BOPP, polyester, polyethylene or any suitable filmic label stock material known in the art. The second film may have a thickness of from 30 μm to 100 μm, for example 50 μm.

The first film may be bonded (e.g. laminated) to the second film via a layer of lamination adhesive. The lamination adhesive may be any suitable lamination adhesive known in the art, for example a water based acrylic adhesive, solvent based acrylic adhesive, hot melt adhesives, UV cured adhesive and the like.

The method may include a further step of applying a layer of lamination adhesive to the second film.

The second film may be provided with a layer of resealable adhesive disposed on the underside of the second film. The resealable adhesive may be any suitable resealable adhesive, for example a pressure sensitive adhesive, a water based adhesive, solvent based adhesive, a UV cured adhesive, a hot melt adhesive or other suitable resealable adhesives known in the art.

The second film may be provided on a release liner, for example a polyester or glassine release liner.

The method may further comprise a step of die cutting the first film and the second film to form a peelable label having a main panel and a finger lift tab.

The method may further comprise a step of printing the second film prior to being bonded (e.g. laminated) with the first film; for example, the second film may be printed with colour, text, images and branding etc. The second film may be printed by, for example, gravure printing, flexo printing, litho printing, digital printing or other suitable printing methods known in the art.

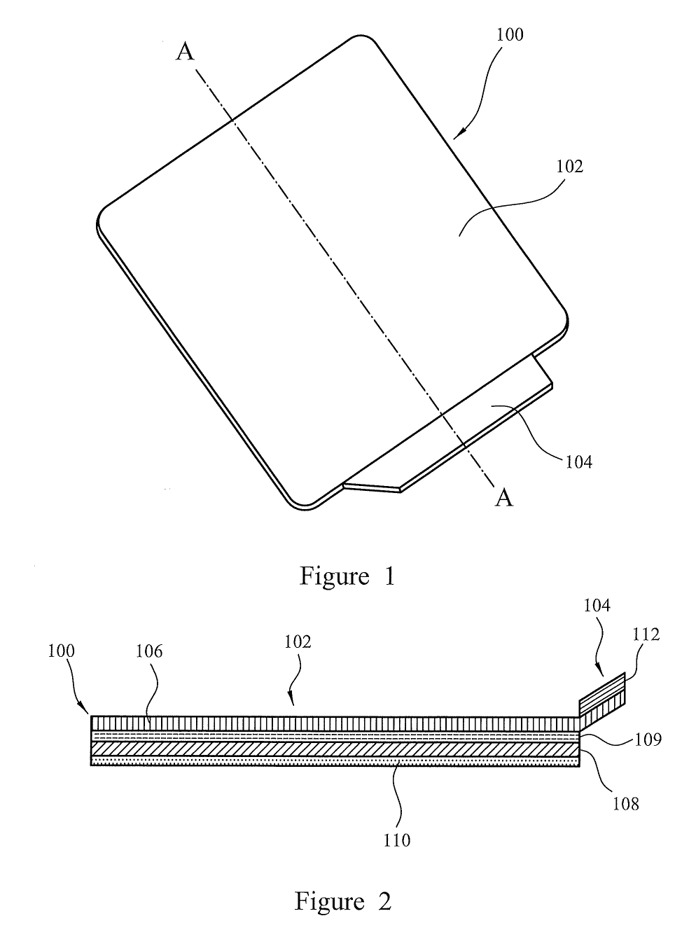

In a further aspect of the present invention there is provided a peelable label substantially as described herein with reference to FIGS. 1 to 4.

Preferred embodiments of the present invention will now be described, by way of example only, with reference to the accompanying drawings, in which:

FIG. 1 is a perspective view of a peelable label.

FIG. 2 is a sectional view of the peelable label along the line A-A of FIG. 1.

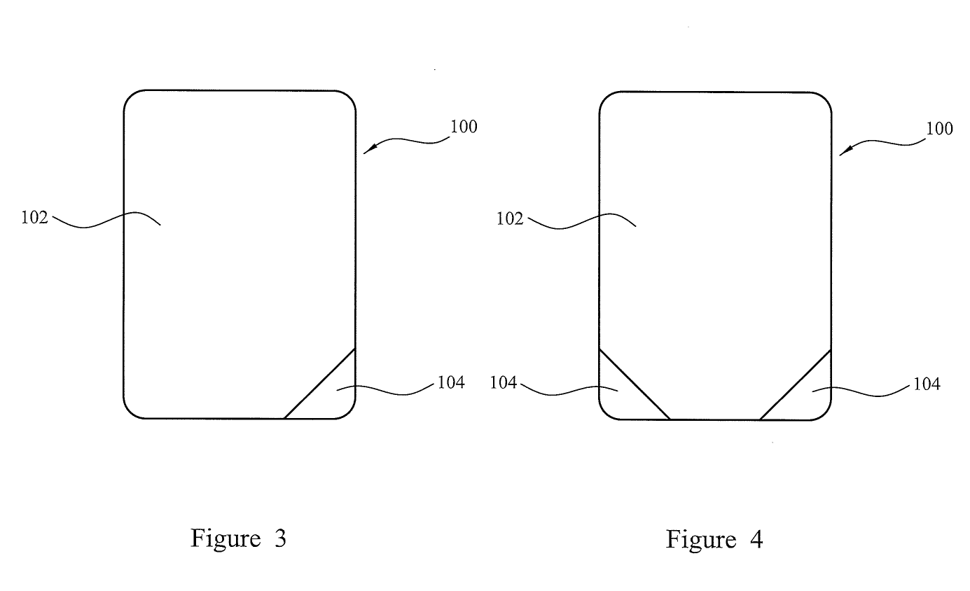

FIG. 3 is a plan view of a peelable label.

FIG. 4 is a plan view of a peelable label.

FIG. 1 shows a perspective view of a peelable label according to the current invention.

The peelable label 100 comprises a main panel 102 and a finger lift tab 104 which is deflected from the plane of the main panel 102. FIG. 1 shows the finger lift tab 104 extending longitudinally from the main panel 102, although other finger lift tab configurations are possible, as shown, for example, in FIGS. 3 and 4.

FIG. 2 is a sectional view of the peelable label 100 along the line A-A shown in FIG. 1. The peelable label 100 comprises a main panel 102 and a finger lift tab 104. The main panel 102 comprises a first film in the form of a lamination film 106, a layer of lamination adhesive 109, a second film in the form of a base film 108, and a layer of resealable adhesive 110.

The lamination film 106 may be a transparent biaxially oriented polypropylene (BOPP) film or a polyester film, having a thickness of 50 μm. The base film 108 may be a metallised biaxially oriented polypropylene (BOPP) film or a polyethylene film, having a thickness of 30 μm. The layer of lamination adhesive 109 is disposed between the base film 108 and the lamination film 106. The lamination adhesive 109 may be any suitable lamination adhesive, for example a water based acrylic adhesive, solvent based acrylic adhesive, hot melt adhesives, UV cured adhesive and the like.

The layer of resealable adhesive 110 is disposed on the underside of the base film 108. The resealable adhesive 110 may be any suitable resealable adhesive, for example a pressure sensitive adhesive, a water based adhesive, solvent based adhesive, a UV cured adhesive, a hot melt adhesive or other suitable resealable adhesives known in the art. The resealable adhesive 110 may be an adhesive that remains substantially adherent after continuous use.

The finger lift tab 104 comprises the lamination film 106 and a single or multiple layers of varnish 112 disposed on the upper surface of the finger lift tab 104. The finger lift tab 104 does not include a base film 108, i.e. the base film 108 is only coextensive with the main panel 102, such that the portion of the lamination film 106 that is not coextensive with the main panel 102 defines the finger lift tab 104. The layers of varnish 112 disposed on the upper surface of the finger lift tab 104 cause the finger lift tab 104 to be deflected from the plane of the main panel 102, enabling the user to grasp the finger lift tab 104 easily.

FIGS. 3 and 4 show plan views of further examples of the peelable label 100. FIG. 3 shows a peelable label 100 in which the finger lift tab 104 is positioned in the corner of the peelable label 100. FIG. 4 shows a plan view of a peelable label 100, in which there are two finger lift tabs 104 positioned in each corner of the peelable label 100.

The method of making a peelable label as shown in FIGS. 1 to 4 is described below.

A web of base stock material is formed and advanced in the web direction. Herein the term “web direction” means the longitudinal direction of the web, and is, for example, the direction in which for example the base stock substrate advances during the manufacturing process.

The web of base stock material comprises a metallised BOPP base film. Disposed on the underside of the base film is a layer of resealable adhesive, which is adhered to a release liner. The release liner may comprise any suitable release liner material such as polyester or glassine.

The web of base stock substrate is advanced in the web direction W and the base stock substrate is cut, for example die cut. The base stock substrate includes a main panel region and a finger lift tab region. The base stock substrate is cut at the boundary of the main panel region and the finger lift tab region. The base film and the layer of resealable adhesive is cut, but the release liner is not cut.

After the base stock substrate is cut, the web of base stock substrate continues to advance and the finger lift tab region is removed. It will be appreciated that the remaining base stock substrate goes on to form the base film of the peelable label.

The base film may be printed, for example by gravure printing, flexo printing, litho printing, digital printing or other suitable printing method known in the art. In some examples, the base film may be printed prior to the cutting process set out above.

The cut web of base stock substrate is advanced and a web of lamination film in the form of a transparent BOPP film is laminated to the base film via a lamination adhesive to form a label stock substrate. The label stock substrate comprises the lamination film and the base film adhered to the release liner.

The web of lamination film comprises a main panel region and a finger lift tab region that correspond with the main panel region and the removed finger lift tab region of the base film. The portion of the lamination film that is not coextensive with the main panel region forms the finger lift tab region.

The label stock substrate continues to advance in the web direction W and a varnish is applied to the upper surface of the lamination film in the finger lift tab region.

The web of label stock substrate is subsequently cut and stripped to form a plurality of peelable labels 100 disposed on the release liner. The varnish is cured, resulting in the finger lift tabs 104 being deflected from the plane of the main panel 102. The finger lift tab 104 may be deflected at an angle of up to 90 degrees from the plane of the main panel 102. The finger lift tab 104 remains free of adhesive on its underside, so the finger lift tab 104 does not adhere, in use, to, for example, the release liner or product packaging.

The web continues to advance with a plurality of peelable labels 100 adhered to the release liner. The plurality of peelable labels are wound on to a drum to form a wound reel of peelable labels.

The peelable labels 100 adhered to the release liner may be removed from the release liner and applied to packaging by methods known in the art. The peelable labels 100 may be adhered to packaging to enclose a packaging opening and seal the packaging. In use, the finger lift tab 104 may be grasped and pulled to partially remove the peelable label 100 to expose the packaging opening. The peelable label 100 may then be re-adhered to the packaging to cover the packaging opening and reseal the packaging.

1. A peelable label comprising:
a main panel and a finger lift tab;
wherein the main panel and the finger lift tab comprise a first film; and
wherein the finger lift tab comprises one or more layers of a chemical composition configured to cause the finger lift tab to be deflected from the plane of the main panel.

2. A peelable label according to claim 1, wherein the chemical composition comprises a varnish.

3. A peelable label according to claim 1, further comprising a second film which is coextensive with the main panel, such that the finger lift tab is defined by the portion of the first film that is not coextensive with the main panel.

4. A peelable label according to claim 3, further comprising a layer of adhesive disposed between the first film and the second film.

5. A peelable label according to claim 1, further comprising a layer of resealable adhesive disposed on the underside of the main panel.

6. A peelable label according to claim 1, wherein the finger lift tab extends from the main panel towards a corner of the peelable label, such that the corner of the peelable label is deflectable from the plane of the main panel.

7. A peelable label according to claim 1, comprising two finger lift tabs, wherein each finger lift tab extends from the main panel towards a corner of the peelable label, such that each of the corners of the peelable label is deflectable from the plane of the main panel.

8. A peelable label according to claim 1, wherein the finger lift tab extends longitudinally from the main panel.

9. A peelable label according to claim 2, wherein the first film and/or the second film comprise a biaxially oriented polymer.

10. A wound reel of peelable labels comprising a release liner and a plurality of peelable labels according to claim 1, releasably adhered to the release liner.

11. Packaging for at least one article or substance, comprising:
a main packaging portion having a packaging opening; and
a peelable label according to claim 1,
the peelable label being adhered to the main packaging portion with the main panel covering the packaging opening and at least part of the finger lift tab being deflected away from the main packaging portion;
wherein, in use, pulling the main panel away from the main packaging portion by means of the finger lift tab causes the packaging opening to be exposed.

12. A method of manufacturing a peelable label comprising:
forming a first film having a main panel region and a finger lift tab region;
applying a layer of resealable adhesive to the main panel region;
and applying one or more layers of a chemical composition (e.g. a varnish) to the finger lift tab region of the first film to thereby cause the finger lift tab region to deflect from the plane of the main panel region.

13. A method of manufacturing a peelable label comprising:
forming a second film comprising a main panel region and a finger lift tab region;
cutting the second film to remove the finger lift tab region;
bonding a first film to the second film to thereby form a peelable label comprising a main panel and a finger lift tab, wherein the finger lift tab is defined by the portion of the first film that is not coextensive with the main panel;
applying one or more layers of a chemical composition (e.g. a varnish) to the finger lift tab to thereby cause the finger lift tab to be deflected from the plane of the main panel.

14. A method according to claim 12, further comprising:
die cutting the first film and the second film to form a peelable label, having a main panel and a finger lift tab.

15. A method according to claim 12, wherein the second film is provided on a release liner.

16. (canceled)
